(19) United States
(12) Patent Application Publication
(10) Pub. No.: US 2010/0148511 A1
(43) Pub. Date: Jun. 17, 2010

(54) WAVE ELECTRIC POWER PLANT

(76) Inventors: Vyacheslav Viktorovich Ovsyankin, Glevakha Vasilkovsky (UA); Aleksey Vyacheslavoich Ovsyankin, Gieva Kha Vasikovsk (UA); Aleksii Antonovich Kovalskyi, Starokievakaya (UA)

Correspondence Address: John Alumit, 16830 Ventura Blvd. Suite 360, Encino, CA, 91436, US

(21) Appl. No.: 12/694,526

(22) Filed: Jan. 27, 2010

(30) Foreign Application Priority Data
Jul. 27, 2007 (UA) PCT/UA2007/000076

(51) Int. Cl. F03B 13/20

(52) U.S. Cl. 290/53

(57) ABSTRACT

The inventive wave electric power plant is used for converting surface wave energy, and relates to hydraulic power engineering. The aim of the invention is to design a reliable, long-life and low material content wave electric power plant exhibiting a stable, increased performance for the extended range of wave parameters. The aim is achieved by the fact that the wave electric power plant comprises an energy absorbing element (3) in the form of a flexible longitudinal body and working shafts (2) which are sufficiently floatable and used as a common platform. The energy absorbing element (3) consists of individual parts interconnected in such away that they are freely displaceable with respect to each other along the working shaft (2) axis, and rigidly withstand a force acting in a vertical direction. The structure is provided with a dipping system (11) and stabilizers (7).

### CROSS-REFERENCE TO RELATED APPLICATION

This application claims the benefit of the priority filing date in PCT/UA2007/000076 referenced in WIPO Publication WO/2009/023000. The earliest priority date claimed is Jul. 27, 2007.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention pertains to the field of hydropower engineering and can be used for converting the energy of water surface waves into electric energy.

Known are various devices for converting the energy of water surface waves into electric energy, in particular, the devices described in David Ross' book “Wave Energy,” L. Gidrometeoizdat, 1982.

However, as far as generating a significant amount of energy is concerned, which is of great practical interest, most of them have considerable shortcomings:

a “Coccarell raft” type device (England) requires a complicated conversion mechanism;

a “Sotlair duck” type device (England) is cumbersome, difficult to manufacture and operate, and requires a complicated conversion mechanism;

a “Masuda column” device (Japan) requires additional complicated devices for stabilizing them in a storming sea.

Known is a device comprising an actuator that is made in the shape of a floating rotor and has the shape of a spiral-shaped helical body which makes it possible to directly convert wave energy when the actuator rotates to mechanical energy (USSR Certificate of Authorship No. 72103).

The device's shortcoming is its low efficiency attributable to rigidly specified dimensions and the shape of the spiral rotor, which seldom matches parameters of waves in a real sea environment. Moreover, the device is difficult to manufacture.

Common shortcomings of the above-referenced devices for converting the energy of sea waves into electric energy are their low efficiency, high material content, complexity of manufacture, ability for operation in only a narrow wave range, low durability, and short life.

The prototype of the claimed invention is a wave-powered electric power plant, i.e., a device for converting the energy of water surface waves into electric energy comprising an actuator in the form of a flexible longitudinal body located freely in slots of several guideways. Each guideway can turn about a common shaft installed on a floating platform, transferring torque in only one direction, and allowing the flexible longitudinal body to take the shape of a spiral rotor with parameters corresponding to the respective size of actuating waves (Ovsyankin, V. V., Patent of Ukraine No. 56481, published in Bulletin No. 3/2005).

The prototype has the following shortcomings:

low durability of the design in stormy seas; high probability of destruction of the flexible longitudinal body and structural elements in the case of unavoidable relative stresses and deformations generated in the flexible longitudinal body when it takes the shape of a spiral rotor; and

low actuator efficiency in the case of large deflection of the flexible longitudinal body under action of the oncoming wave's hydrodynamic head.

The objective of the invention is to increase the durability and life of a wave-powered electric power plant that has lower material content and a stable high efficiency.

The stated objective is achieved by the fact that in the known design of a wave-powered electric power plant comprising an energy absorbing member made in the shape of a flexible longitudinal body freely located in slots of several guideways, each guideway has the capability of turning about a common working shaft installed on a floating platform, transferring axial torque to the shaft only in one direction, and making it possible for the flexible longitudinal body to take the shape of a spiral rotor with parameters corresponding to the dimensions of acting waves, there are: at least two working shafts that have sufficient buoyancy and, along with the transferring axial torque, perform the function of a common floating platform; transverse frames for connecting the working shafts to each other; and umbrella-like dampers for stabilizing the power plant position in stormy seas.

The stated objective is also achieved by the fact that the energy absorbing member of the wave-powered electric power plant is comprised of individual flat parts connected to each other in an overlapping fan shape so that they can move freely with respect to each other along the working shaft's longitudinal axis and withstand, with high rigidity, the action of the head in the perpendicular direction.

The stated objective is also achieved by the fact that the wave-powered electric power plant is equipped with a system for submersion to the required depth, into the action zone of waves, that the electric power plant is designed for.

### SUMMARY

A wave-powered electric power plant that has lower material content and a stable high efficiency achieved by the fact that in the known design of a wave-powered electric power plant comprising an energy absorbing member made in the shape of a flexible longitudinal body freely located in slots of several guideways, each guideway has the capability of turning about a common working shaft installed on a floating platform, transferring axial torque to the shaft only in one direction, and making it possible for the flexible longitudinal body to take the shape of a spiral rotor with parameters corresponding to the dimensions of acting waves, there are: at least two working shafts that have sufficient buoyancy and, along with the transferring axial torque, perform the function of a common floating platform; transverse frames for connecting the working shafts to each other; and umbrella-like dampers for stabilizing the power plant position in stormy seas.

The stated objective is also achieved by the fact that the energy absorbing member of the wave-powered electric power plant is comprised of individual flat parts connected to each other in an overlapping fan shape so that they can move freely with respect to each other along the working shaft's longitudinal axis and withstand, with high rigidity, the action of the head in the perpendicular direction.

### FIGURES

FIG. 1 shows the top view of the wave-powered electric power plant.

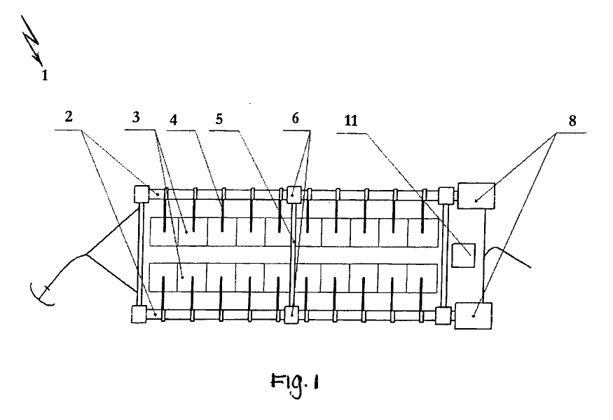

FIG. 2 shows an example of the wave-powered electric power plant location in an area of water.

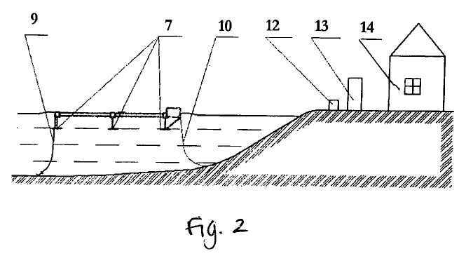

### DESCRIPTION

Wave-powered electric power plant 1 comprising working shafts with transmission 2, energy absorbing members 3, guideways 4, transverse frames 5, pillow blocks 6, umbrella-like dampers to stabilize the electric power plant position in stormy seas 7, generator module 8, anchor system 9, cable system 10, submergence system 11, substation 12, energy management and storage systems 13, and customer 14.

The wave-powered electric power plant 1 is installed in deep water sea.

The wave-powered electric power plant 1 works as follows. Hydrodynamic heads of sea waves coming on the wave-powered electric power plant 1, particularly on the working shafts with transmission 2, interacts with energy absorbing members 3 and creates axial torque on the working shafts with transmission 2. The transmission converts the axial torque and transmits it to the generator module 8. The cable system 10 transmits electric power from the generator module 8 onshore to the substation 12, the energy management and storage systems 13 and to the customer 14. The electric power plant's position in the sea is set by the anchor system 9. When a wave comes, position stabilization is provided by umbrella-like dampers. Floating working shafts with transmission 2 connected by means of transverse frames 5 ensure high durability of the electric power plant. In the case of strong storms, the submersion system 11 lowers the wave-powered electric power plant 1 to the required depth, into the action zone of waves, the power plant was designed for, and the power plant continues operation there.

The claimed wave-powered electric power plant makes it possible to reduce material content by 67-80% (to 200 kg/kW), and capital intensity by 50-67% (1500-2000 thousand dollars/kW) compared to current wave-powered electric power plants.

The rated capacity load ratio of the electric power plant is as high as 0.8, while for current wave-powered electric power plants, the wave-powered electric power plant parameter is 0.3-0.4.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A wave-powered electric power plant comprising an energy absorbing member made in the shape of a flexible longitudinal body freely located in slots of several guideways, each guideway having the capability of turning about a common working shaft with a transmission installed on a floating platform, transferring axial torque to the working shaft only in one direction, and making it possible for the flexible longitudinal body to take the shape of a spiral rotor with parameters corresponding to the dimensions of on-coming water surface waves, distinct in that it comprises:
at least two working shafts that have sufficient buoyancy and, along with transmitting axial torque, perform the function of the floating platform;
transverse frames connecting the working shafts to each other; and
umbrella-like dampers to stabilize the electric power plant's position in stormy seas.

2. A wave-powered electric power plant per claim 1, distinct in that the energy absorbing member is comprised of individual flat parts connected to each other in an overlapping fan shape so that they can move freely with respect to each other along the working shaft's longitudinal axis and withstand, with high rigidity, the action of hydroponic heads of sea waves in a perpendicular direction.

3. A wave-powered electric power plant per claim 1, distinct in that it is equipped with a system for submersion to the required depth, into the action zone of waves, that the electric power plant is designed for.

4. A wave-powered electric power plant per claim 2, distinct in that it is equipped with a system for submersion to the required depth, into the action zone of waves, that the electric power plant is designed for.
